(19) United States
(12) Patent Application Publication
(10) Pub. No.: US 2014/0311976 A1
(43) Pub. Date: Oct. 23, 2014

(54) Extraction Processes

(71) Applicant: ExxonMobil Chemical Patents Inc., Baytown, TX (US)

(72) Inventors: Michael P. Sheehan, Friendswood, TX (US); Bernie J. Pafford, Houston, TX (US); James I. Arnett, II, Greenwell Springs, LA (US)

(21) Appl. No.: 14/225,861

(22) Filed: Mar. 26, 2014

Related U.S. Application Data
(60) Provisional application No. 61/813,979, filed on Apr. 19, 2013.

(51) Int. Cl. C02F 1/26

(52) U.S. Cl. CPC C02F 1/26
USPC 210/634

(57) ABSTRACT

A process for treating a water-acid mixture includes contacting the water-acid mixture with a hydrocarbon solvent to remove at least a portion of the acid from the mixture to produce a treated liquid. The ratio of the hydrocarbon solvent to water-acid mixture is between 2:1 and 5:1.

### CROSS-REFERENCE TO RELATED APPLICATIONS

The present application claims the benefit of priority from U.S. Ser. No. 61/813,979, filed on Apr. 19, 2013.

### BACKGROUND OF THE INVENTION

Lubricants in commercial use today are prepared from a variety of natural and synthetic base stocks admixed with various additive packages and solvents depending upon their intended application. Generally, base stocks include mineral oils, highly refined mineral oils, polyalpha-olefins (PAOs), polyalkylene glycols (PAGs), phosphate esters, silicone esters, diesters, and polyol esters.

Of these base stocks, polyol esters have been frequently favored for use in, for example, aircraft turbine oils, engine oils, transmission fluids, hydraulic fluids, and greases. Commercial products are available under the tradename, ESTEREX™ Polyol Esters available from ExxonMobil Chemical, Houston, Tex. Polyol esters may be produced by esterifying alcohols, typically, polyols, such as, pentaerythritol, and one or more carboxylic acids, such as, pentanoic acid (also known as valeric acid) and hexanoic acid (also known as caproic acid), to produce the esters. See, for example, U.S. Pat. Nos. 6,177,387, 5,744,434, 5,698,502, and 5,674,822.

In the production of polyol esters, waste water management containing organic materials poses many challenges, especially among the back-drop of evolving environmental regulations. Among these challenges is the management of residual carboxylic acids that may be present in waste water. Esters are made by reacting fatty acids with alcohols producing water. The esterification process is readily reversible such that removal of water is required for high levels of conversion. During the esterification reaction, water vapor and excess acid (used as a catalyst) moves overhead from the reactor through a heat exchanger, where the vapor is condensed and captured in a collection vessel. The generally azeotropic mixture of water and acid then cools, allowing the dense water and lighter acid to phase separate from each other. The lighter acid phase then refluxes back to the reactor system. The separated water is then collected in a tank for proper disposal. Some fatty acids, however, especially short chain fatty acids such as those with aliphatic tails of 5 to 7 carbons, may remain in the waste water due to relatively high water solubility. The waste water requires proper treatment to comply with environmental regulations. Removal of fatty acid contaminants from waste water requires application of a solvent system that reduces the contaminant without introduction of alternate organic material to the waste stream.

In other areas, aqueous solutions have been treated with organic solvents to reduce the levels of caproic or valeric acids. For example, U.S. Pat. No. 5,254,255 discloses the manufacture of adipic acid by the carbonylation of butadiene. During the production process an aqueous solution containing adipic acid and/or methyl glutaric acid and caproic acid and/or valeric acid is formed. The Patent teaches that it is desirable to reduce the caproic acid and/or valeric acid from this aqueous solution. To achieve this reduction, U.S. Pat. No. 5,254,255 suggests, among other things, using an additional “extraction-enhancing acid” (col. 1, lines 47-53) and treating the aqueous solution with an organic solvent at the ratio of solvent to aqueous solution of 0.5 to 2.5 (col. 2, lines, 24-27).

Despite past endeavors, there exists a need for simpler process designs that are able to remove more of the organic materials, such as carboxylic acids without introduction of alternate organic compounds used as extraction solvents to the waste water.

### SUMMARY OF THE INVENTION

The invention provides for embodiments directed to a process for treating a liquid mixture including water and at least one carboxylic acid, the process includes contacting the liquid mixture with a hydrocarbon solvent to remove at least a portion of the at least one carboxylic acid from the liquid mixture to produce a treated liquid; wherein the ratio of the hydrocarbon solvent to liquid mixture is between 2:1 and 5:1.

### DETAILED DESCRIPTION OF THE INVENTION

Polyol esters may be produced by esterifying alcohols, typically, polyols, such as, pentaerythritol, and one or more carboxylic acids, such as, pentanoic acid and hexanoic acid to produce the esters. See, for example, U.S. Pat. Nos. 6,177,387, 5,744,434, 5,698,502, and 5,674,822.

In the commercial implementation of this process, waste water management of organic materials poses many challenges. Among these challenges is the management of residual carboxylic acids that may be present in waste water.

In several classes of embodiments of the invention disclosed herein, the waste water or liquid mixture may be treated to remove or reduce the organic material, such as, at least one carboxylic acid from the liquid mixture. In particular, the process may include contacting a liquid mixture made up of water and at least one carboxylic acid with a hydrocarbon solvent to remove at least a portion of the at least one carboxylic acid from the liquid mixture to produce a treated liquid; wherein the ratio of the hydrocarbon solvent to water is between 1:1 and 6:1. Alternatively, the ratio of the hydrocarbon solvent to water may be between 2:1 and 5:1, alternatively between 2:1 and 4:1, or alternatively between 3:1 and 4:1. These processes employ principles and techniques commonly referred to in industry as solvent extraction or liquid-liquid extraction.

### Extraction Processes

Solvent extraction, also referred to as liquid-liquid extraction or partitioning, is a method of separating compounds based on their relative solubilities, for example, in at least two immiscible liquids or phases. See, for example, U.S. Pat. Nos. 5,675,043, 5,254,255, and WO 2012/078218. Solvent extraction generally proceeds as an extraction of a substance from one liquid phase into another liquid phase wherein each liquid phase may comprise the same or different solvent(s). In particular, it generally attempts to separate a substance from a mixture by dissolving that substance in a suitable solvent and removing the substance and solvent from the mixture. The mixture may then proceed to further processing. Liquid-liquid extraction is a basic chemical technique and is readily scalable. Thus, it may be applied on a smaller scale in laboratories using, for example, a separatory funnel, as well as on an industrial scale using, for example, large separation towers or columns discussed in more detail below.

The extraction process, including contacting a liquid made up of water and at least one carboxylic acid, hereafter referred to a water-acid mixture, with at least one solvent may occur in any suitable apparatus known in the art capable of performing liquid-liquid extraction. Examples of such apparatuses include without limitation, SCHEIBEL® columns, KARR® columns, rotating disc contactor (RDC) columns, pulsed, packed (SMVP), and sieve tray columns. “Tower” is sometimes used synonymously with “column” as recognized in the art and will be used herein interchangeably unless otherwise stated if not referenced together. Some towers have been described, for example, in Performance of an Internally Baffled Multistage Extraction Column, Scheibel, Edward G., A. I. Ch. E. Journal, March, 1956, pages 74-78, and WO 2011/151123.

Several configurations are useful and may be customized depending upon the particular needs for each project. For example, one or more extraction towers or columns may be included in the process. Such towers or columns are generally devices that contain alternating mixing and settling stages. They may be configured to act as a multiple phase system, for example, two or more phases. Thus, in any aspect of the invention disclosed herein, the extraction process, including contacting the water-acid mixture with at least one solvent may proceed through one or more extraction steps over the course of one or more stages.

The extraction process, including contacting the water-acid mixture with at least one solvent, may be executed in a co-current mode, in which the immiscible liquids (e.g., the water-acid mixture and the solvent) flow in the same direction. Alternatively, the process may be executed in a counter-current mode, where the immiscible liquids flow in opposite directions.

The extraction process, including contacting the water-acid mixture with at least one solvent, may be performed at a temperature in the range from −40° C. to 100° C., alternatively, from −25° C. to 75° C., alternatively, from −30° C. to 75° C., alternatively, from −25° C. to 60° C., and alternatively, from −15° C. to 50° C. In one aspect of the invention, the extraction process may occur at ambient or sub-ambient temperatures. In several aspects of the invention, the pressure should be high enough to keep both phases in essentially the liquid state to facilitate separation of the two phases.

### Solvents

In several aspects of the invention, the solvent used is a hydrocarbon solvent. As used herein, “hydrocarbon solvent” refers to solvents made from molecules comprising predominantly carbon and hydrogen atoms, optionally substituted, if not exclusively comprising carbon and hydrogen atoms. For example, the hydrocarbon solvent may comprise alkanes, including C₄ to C₂₂, alternatively, C₄ to C₁₀, linear, cyclic, branched alkanes, alkenes, aromatics, and mixtures thereof.

In several aspects of the invention, the hydrocarbon solvent may be selected from the group consisting of at least one of a C₄ to C₂₂ alkane, alkene, aromatic, and mixtures thereof.

Examples of hydrocarbon solvents include butane, pentane, hexane, heptane, octane, nonane, decane, undecane, dodecene, cyclopropane, 2-methylbutane, 2,2-dimethylbutane, 2,3-dimethylbutane, cyclobutane, 2-methylpentane, 3-methylpentane, 2,2-dimethylpentane, 2,3-dimethylpentane, 2,4-dimethylpentane, 3,3-dimethylpentane, 2,2,4-trimethylpentane, 3-ethylpentane, cyclopentane, methylcyclopentane, 1,1-dimethylcycopentane, cis-1,2-dimethylcyclopentane, trans-1,2-dimethylcyclopentane, trans-1,3-dimethylcyclopentane, ethylcyclopentane, 2-methylhexane, 3-methylhexane, 2,5-dimethylhexane, 3-ethylhexane, cyclohexane, methylcyclohexane, 2-methylheptane, and mixtures thereof. Other examples of hydrocarbons include benzene, toluene, xylene, ortho-xylene, para-xylene, meta-xylene, and mixtures thereof.

A preferred solvent may be chosen based upon several factors. The preferred solvent should be highly immiscible with water. In this way, the extraction process does not merely replace one unwanted organic compound, i.e., carboxylic acid, in the waste water with another organic compound, e.g., solvent. The preferred solvent should also be capable of extracting the at least one carboxylic acid. Additionally, the preferred solvent should be manageable to implement in a large scale commercial process, e.g., be permitted for use under applicable safety, health, and environmental standards. For example, the preferred solvent should have an adequately high flash point to pass applicable safety permits for commercial use. Heptane is highly immiscible with water, capable of extracting carboxylic acids, and has a flash point of about −4.0° C., and thus the hydrocarbon solvent may preferably comprise or consist essentially of heptane.

In any aspect of the invention described herein, the hydrocarbon solvent may be “essentially free” of any carboxylic acid prior to contacting the water-acid mixture. As used herein “essentially free” shall refer to 1,000 wt ppm or less, alternatively, 500 wt ppm or less alternatively, 250 wt ppm or less, alternatively, 100 wt ppm or less, alternatively, 50 wt ppm or less, alternatively, 10 wt ppm or less, and alternatively, 5 wt ppm or less. This ensures the extraction process does not merely replace one unwanted carboxylic acid in the water-acid mixture with another unwanted carboxylic acid.

### Carboxlyic Acids

The water-acid mixture includes water and at least one carboxylic acid. The at least one carboxylic acid may be a monocarboxylic acid (i.e., having one carboxyl group) or a fatty acid. Fatty acids are carboxylic acids with longer aliphatic carbon tails, generally, four or more carbon atoms constituting the aliphatic tail, saturated or unsaturated, along with the appropriate hydrogen atoms.

Examples of carboxylic acids include C₅-C₂₀ linear carboxylic acids, alternatively, C₅-C₁₀ linear carboxylic acids, and C₅-C₂₀ branched carboxylic acids, alternatively, C₅-C₁₀ branched carboxylic acids. Exemplary linear carboxylic acids include, but are not limited to, valeric (pentanoic) acid, caproic (hexanoic) acid, enanthic (heptanoic) acid, caprylic (octanoic) acid, pelargonic (nonanoic) acid, capric (decanoic) acid, lauric (dodecanoic) acid, and mixtures thereof.

Exemplary branched carboxylic acids include iso-C₅, iso-C₆, iso-C₇, iso-C₈, iso-C₉ acids, and mixtures thereof. For a listing of branched acids and mixtures of carboxylic acids, see, U.S. Pat. No. 6,177,387, col. 8, line 33, bridging col. 9, line 20.

In several aspects of the invention, the at least one carboxylic acid is selected from the group consisting of at least one of C₅-C₁₀ linear carboxylic acids, C₅-C₁₀ branched carboxylic acids, and mixtures thereof.

In other aspects of the invention, the at least one carboxylic acid is selected from the group consisting of at least one of pentanoic acid, hexanoic acid, and mixtures thereof.

Aspects of the invention disclosed herein may be useful for treating a number of water-acid mixtures. For example, aspects of the invention disclosed herein have utility in a number of chemical processes that produce water-acid mixtures.

The water-acid mixtures may comprise 2.0 wt % or greater of the carboxylic acid, for example, 3.0 wt % or greater, or alternatively, from 2.0-4.0 wt % or greater, of the carboxylic acid based on quantitative gas chromatography (GC), gas chromatography-mass spectroscopy (GC-MS), and/or total acid number (TAN) titration analysis. However, after contacting the water-acid mixture with the hydrocarbon solvent to form a treated liquid, the treated liquid may contain 1500 wt ppm or less of the carboxylic acid, alternatively, the treated liquid may contain 1200 wt ppm or less of the carboxylic acid, and alternatively, the treated liquid may contain 1000 wt ppm or less of the carboxylic acid, based on quantitative gas chromatography (GC), gas chromatography-mass spectroscopy (GC-MS), and/or total acid number (TAN) titration analysis.

In any of the aspects of the invention described herein, contacting the water-acid mixture with the hydrocarbon solvent may remove 90% or greater of the carboxylic acid to form the treated liquid, alternatively, the hydrocarbon solvent may remove 95% or greater, or even 97% or greater of the carboxylic acid to form the treated liquid.

In aspects of the invention, the water-acid mixture may be, at least in part, a by-product from an esterification process. The water may be a product of the esterification process and the carboxylic acid may be a reactant, catalyst, or both for the esterification process, and in some aspects of the invention, the esterification process may be the sole source of the carboxylic acid in the water-acid mixture. Alternatively stated, no additional carboxylic acids are added to the water-acid mixture or hydrocarbon solvent described above. In any aspect of the invention described herein, no other carboxylic acid may be contacted with the hydrocarbon solvent other than the carboxylic acid in the water-acid mixture or the carboxylic acid reactant/catalyst from an esterification process.

### EXAMPLES

The advantages of the systems and methods described herein will now be further illustrated with reference to the following non-limiting Examples. In the following examples,

Total Acid Number (TAN) was measured according to ASTM Standard D974.

### Examples 1-5

Carboxylic acid extraction performance was measured for several solvents. 35 ml of synthesized waste water and 35 ml solvent were combined in a separatory funnel Each solvent was reagent grade (˜98% pure). The synthesized waste water constituted 95 wt % deionized water and 5 wt % valeric acid and had an initial TAN of 26.5 mg KOH/g. The contents were mixed for one (1) minute, and allowed to settle for one (1) hour at room temperature and pressure (approximately 21° C. and sea level atmospheric pressure). The heavy water phase was removed, weighed and measured for TAN. The results of Examples 1-5 appear in Table 1.

TABLE 1

| | | | Total Acid Number |
|---|---|---|---|
| | | Water Solubility | after Extraction |
| Example | Solvent | (g/100 ml H₂O) | (mg KOH/g) |
| 1 | Ethyl Acetate | 8.3 | 1.44 |
| 2 | Butyl Acetate | 0.7 | 1.39 |
| 3 | Diethyl Ether | 6.9 | 1.22 |
| 4 | Polyol Ester | Unknown | 4.14 |
| | (5 cSt)* | | |
| 5 | Heptane | Immiscible | 4.91 |

*Similar to commercially available ESTEREX ™ NP451 ester

### Examples 6 and 7

Multiple stage carboxylic acid extraction performance was measured for heptane and ethyl acetate. Waste water samples procured from 5 cSt polyol ester production were used. The waste water had an initial valeric acid content of approximately 42,000 ppm and an initial TAN of 22.5 mg KOH/g. Each run of extraction was performed at 1:1 weight ratio of waste water to solvent. During the first run, 100 g waste water was combined with 100 g solvent in a separatory funnel The contents were mixed for two (2) minutes, and allowed to settle for thirty (30) minutes, at room temperature and pressure (approximately 21-22° C. and sea level atmospheric pressure). The heavy water phase was then removed, weighed and measured for TAN. In subsequent runs, the heavy water phase from the previous run was then combined again with solvent at a 1:1 weight ratio and the mixing, settling, separating, and measuring steps were repeated from Run #1. The results of Examples 6 and 7 appear in Table 2.

TABLE 2

| | | Waste Water to | Total Acid Number | |
|---|---|---|---|---|
| Example | | Solvent Ratio | after Extraction | % Acid |
| (Solvent) | Run # | (g:g) | (mg KOH/g) | Reduction |
| 6 | 1 | 100:100 | 4.62 | 79.5 |
| (Heptane) | 2 | 97:97 | 2.02 | 91.0 |
| | 3 | 95:95 | 1.38 | 94.0 |
| | 4 | 92:93 | 0.89 | 96.0 |
| | 5 | 89:89 | 0.73 | 96.8 |
| | 6 | 85:85 | 0.62 | 97.2 |
| | 7 | 80:80 | 0.54 | 97.6 |
| 7 | 1 | 100:100 | 1.18 | 94.8 |
| (Ethyl | 2 | 94:94 | 0.33 | 98.5 |
| Acetate) | 3 | 86:86 | 0.22 | 99.0 |
| | 4 | 77:77 | 0.17 | 99.2 |

### Examples 8-12

Carboxylic acid extraction performance was measured for heptane in plant conditions. Waste water procured from 5 cSt polyol ester production was used. The waste water had an initial valeric acid content of approximately 39,000 ppm and an initial TAN of 21.0 mg KOH/g. The extraction was performed at room temperature (approximately 20-25° C.) in a three (3) inch diameter glass SCHEIBEL® column with multiple stages and constant agitation. The column was filled with heptane as the constant phase. Heptane and waste water were pumped into the column, at the bottom and top respectively, at set feed rates in order to achieve desired mass ratios in the column. Light extract phase was allowed to overflow from the column into a receiver. Heavy water phase was pumped from the bottom of the column.

After the column volume was allowed to turn over three (3) times, samples were taken from the heavy water phase and measured for TAN. This process was repeated for different heptane to waste water ratios. The results for Examples 8-12 appear in Table 3.

TABLE 3

| | | Total Acid | | |
|---|---|---|---|---|
| | Heptane to | Number after | Valeric Acid | |
| | Waste Water | Extraction | Content* | % Acid |
| Example | Ratio (g:g) | (mg KOH/g) | (ppm) | Reduction |
| 8 | 2:1 | 0.58 | 1055 | 97.2 |
| 9 | 3:1 | 0.58 | 1055 | 97.2 |
| 10 | 3.5:1 | 0.53 | 964 | 97.5 |
| 11 | 4:1 | 0.43 | 782 | 98.0 |
| 12 | 5:1 | 0.44 | 800 | 97.9 |

*Calculated based on an acid number of 550 per gram Valeric Acid and assuming acid number is fully accountable from Valeric Acid

The embodiments and examples set forth herein are presented to best explain the present invention and its practical application and to thereby enable those skilled in the art to make and use the invention. However, those skilled in the art will recognize that the foregoing description have been presented for the purpose of illustration and example only. The description set forth is not intended to be exhaustive or to limit the invention to the precise form disclosed. Many modifications and variations are possible in light of the above teaching without departing from the spirit and scope of the claims.

What is claimed is:

1. A process for treating a liquid mixture comprising water and at least one carboxylic acid, the process comprising:
contacting the liquid mixture with a hydrocarbon solvent to remove at least a portion of the at least one carboxylic acid from the liquid mixture to produce a treated liquid; wherein the ratio of the hydrocarbon solvent to liquid mixture is between 2:1 and 5:1.

2. The process of claim 1, wherein the at least one carboxylic acid is selected from the group consisting of at least one of C₅-C₁₀ linear carboxylic acids, C₅-C₁₀ branched carboxylic acids, and mixtures thereof.

3. The process of claim 1, wherein the at least one carboxylic acid is selected from the group consisting of at least one of pentanoic acid, hexanoic acid, heptanoic acid, octanoic acid, nonanoic acid, decanoic acid, dodecanoic acid, and mixtures thereof.

4. The process of claim 3, wherein the at least one carboxylic acid is selected from the group consisting of at least one of pentanoic acid, hexanoic acid, and mixtures thereof.

5. The process of claim 1, wherein the hydrocarbon solvent is selected from the group consisting of at least one of a C₄ to C₂₂ alkane, alkene, aromatic, and mixtures thereof.

6. The process of claim 5, wherein the hydrocarbon solvent is selected from the group consisting of at least one of butane, pentane, hexane, heptane, octane, nonane, decane, undecane, dodecene, cyclopropane, 2-methylbutane, 2,2-dimethylbutane, 2,3-dimethylbutane, cyclobutane, 2-methylpentane, 3-methylpentane, 2,2-dimethylpentane, 2,3-dimethylpentane, 2,4-dimethylpentane, 3,3-dimethylpentane, 2,2,4-trimethylpentane, 3-ethylpentane, cyclopentane, methylcyclopentane, 1,1-dimethylcycopentane, cis-1,2-dimethylcyclopentane, trans-1,2-dimethylcyclopentane, trans-1,3-dimethylcyclopentane, ethylcyclopentane, 2-methylhexane, 3-methylhexane, 2,5-dimethylhexane, 3-ethylhexane, cyclohexane, methylcyclohexane, 2-methylheptane, benzene, toluene, xylene, ortho-xylene, para-xylene, meta-xylene, and mixtures thereof.

7. The process of claim 6, wherein the hydrocarbon solvent comprises heptane.

8. The process of claim 1, wherein the ratio of the hydrocarbon solvent to liquid mixture is between 2:1 and 4:1.

9. The process claim 8, wherein the ratio of the hydrocarbon solvent to liquid mixture is between 3:1 and 4:1.

10. The process of claim 1, wherein the contacting comprises one or more extraction steps comprising one or more stages.

11. The process claim 1, wherein the liquid mixture comprises 3.0 wt % or greater of the at least one carboxylic acid.

12. The process of claim 1, wherein the treated liquid comprises 1500 wt ppm or less of the at least one carboxylic acid.

13. The process of claim 12, wherein the treated liquid comprises 1200 wt ppm or less of the at least one carboxylic acid.

14. The process of claim 13, wherein the treated liquid comprises 1000 wt ppm or less of the at least one carboxylic acid.

15. The process of claim 1, wherein contacting the liquid mixture with the hydrocarbon solvent removes 90% or greater of the at least one carboxylic acid to form the treated liquid.

16. The process of claim 15, wherein contacting the liquid mixture with the hydrocarbon solvent removes 95% or greater of the at least one carboxylic acid to form the treated liquid.

17. The process of claim 16, wherein contacting the liquid mixture with the hydrocarbon solvent removes 97% or greater of the at least one carboxylic acid to form the treated liquid.

18. The process of claim 1, wherein the liquid mixture comprises a by-product from an esterification process and the at least one carboxylic acid comprises a reactant, a catalyst, or both a reactant and catalyst of the esterification process.

19. The process of claim 1, wherein the hydrocarbon solvent is essentially free of any carboxylic acid prior to contacting the liquid mixture with the hydrocarbon solvent.

20. The process of claim 1, wherein no other carboxylic acid is contacted with the hydrocarbon solvent other than the at least one carboxylic acid in the liquid mixture and wherein the at least one carboxylic acid is a reactant, catalyst, or both a reactant and catalyst from an esterification process.
